(19) United States
(12) Patent Application Publication
(10) Pub. No.: US 2009/0323555 A1
(43) Pub. Date: Dec. 31, 2009

(54) System and Method for Controlling and Configuring a Router

(75) Inventors: Arthur Lancaster, Austin, TX (US); Melissa Simpler, Austin, TX (US); Todd Greer, Austin, TX (US)

Correspondence Address: TOLER LAW GROUP, 8500 BLUFFSTONE COVE, SUITE A201, AUSTIN, TX, 78759, US

(73) Assignee: Affinegy, Inc.

(21) Appl. No.: 12/492,215

(22) Filed: Jun. 26, 2009

Related U.S. Application Data
(60) Provisional application No. 61/076,205, filed on Jun. 27, 2008.

(51) Int. Cl. H04L 12/56; H04L 12/28

(52) U.S. Cl. 370/254; 370/401

(57) ABSTRACT

Methods and systems for configuring a network are provided. A method may include monitoring properties of a connection between a network device and a network. The method may also include detecting a change in the properties of the connection. The method may also include verifying the connection to the network is provided by a service provider when the change in the properties is detected and providing network configuration options based on the change.

### CROSS REFERENCE TO RELATED APPLICATIONS

The present application claims priority from U.S. Provisional Patent Application No. 61/076,205 filed on Jun. 27, 2008 and entitled “SYSTEM AND METHOD FOR CONTROLLING AND CONFIGURING A ROUTER.”

### FIELD OF THE DISCLOSURE

The present disclosure is generally related to wireless networks and to controlling and configuring a router.

### BACKGROUND

A home or small business may have a network to allow access to an external network. The network may be accessed using one or more network devices, such as a personal computer, a laptop, a phone, or a personal digital assistant (PDA). Often, each network device may be capable of communicating with another network device using a wired protocol or a wireless protocol. An example of a wired protocol is Ethernet. Examples of wireless protocols include IEEE 802.11 (“Wi-Fi”), Bluetooth, Wireless Universal Serial Bus (USB), Code Division Multiple Access (CDMA), and Global System Mobile (GSM).

In order to allow a network device in the home or small business to communicate with an external network, such as the Internet, a wireless router may be used to set up a wireless network, such as a Wi-Fi network. The wireless router may also be known as a wireless access point. The wireless router may have a wired connection to an external network, such as the Internet, and may broadcast a wireless signal to allow wireless-capable network devices access to the external network.

Configuring the wireless network to secure the network may include manually enabling and manually setting the wireless router's security settings. Also, each network device's access settings may be manually enabled and manually set. The process of manually enabling and manually setting the wireless router's security settings may be quite complex, making the process frustrating for users, especially for those who are not technically savvy. Therefore, there is a need for an improved system and method for controlling and configuring a router.

### BRIEF DESCRIPTION OF THE DRAWINGS

FIG. 1 is a block diagram of an embodiment of a wireless network and a system to control and configure a router;

FIG. 2 is a flow chart of a first illustrative embodiment of a method of controlling and configuring a router;

FIG. 3 is a flow chart of a second illustrative embodiment of a method of controlling and configuring a router;

FIG. 4 is a flow chart of a third illustrative embodiment of a method of controlling and configuring a router; and

FIG. 5 is a flow chart of a fourth illustrative embodiment of a method of controlling and configuring a router; and

FIG. 6 is a flow chart of a fifth illustrative embodiment of a method of controlling and configuring a router;

FIG. 7 is a flow chart of a sixth illustrative embodiment of a method of controlling and configuring a router;

FIG. 8 is a flow chart of a seventh illustrative embodiment of a method of controlling and configuring a router; and

FIG. 9 is a block diagram of an illustrative embodiment of a network device.

### DETAILED DESCRIPTION OF THE DRAWINGS

In a particular embodiment, a method may include identifying a first network device in communication with a computer via a network. The method may include searching a library of network device commands at the computer for commands that are associated with the first network device. The method may also include determining at the computer a set of commands that are executable by the first network device. The method may also include sending at least one control command from the computer that is executable by the first network device to configure the first network device.

In a particular embodiment, a system may include a processor and a memory that is accessible to the processor. The memory may include instructions that are executable by the memory to detect a network device that is accessible to the computer via a network. The memory may also include instructions that are executable by the memory to probe a network management interface of the network device via the network. The memory may also include instructions that are executable by the memory to determine a set of commands that are executable by the network device to configure the network device. The memory may also include instructions that are executable by the memory to store the set of commands in a library of network device commands.

In a particular embodiment, a computer readable medium may include computer readable instructions executable by a processor to record user input at a computer. The user input may correspond to configuration commands that are executable by a network device that is in communication with the computer via a network. The computer readable instructions may also be executable by a processor to generate a set of the configuration commands. The computer readable instructions may also be executable by a processor to store the set of configuration commands to a library of network device commands.

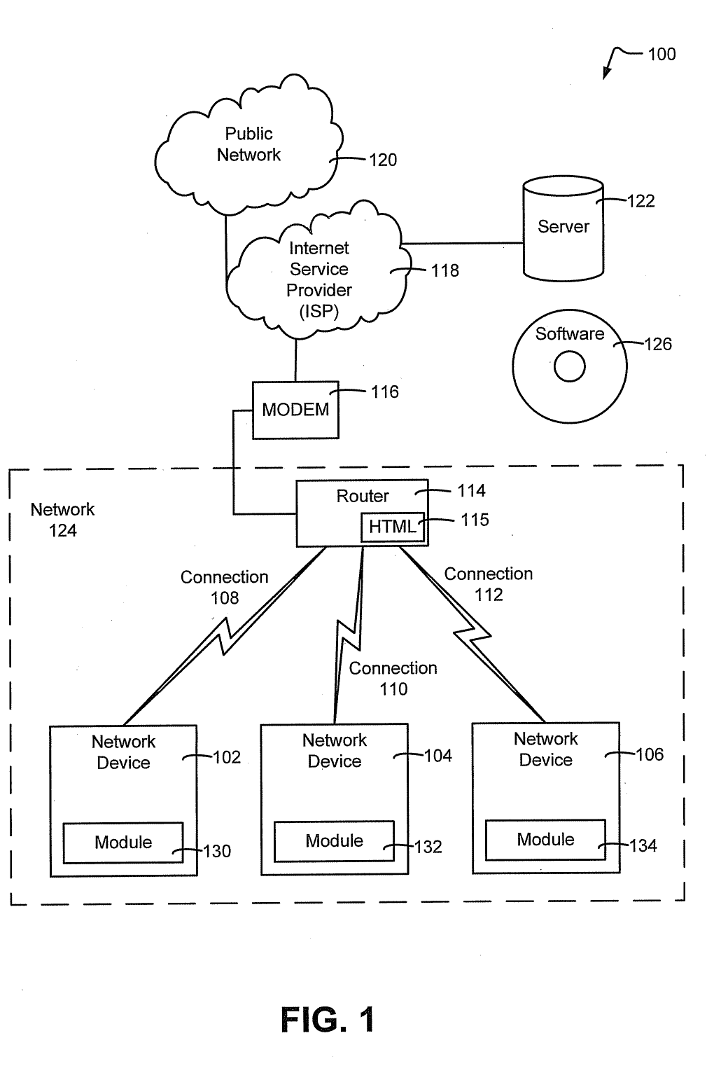

FIG. 1 is an illustrative embodiment of a network 100. In the network 100, network devices 102, 104, and 106 connect via connections 108, 110, and 112 to router 114. Each of the network devices 102-106 may be a personal computer, a laptop, a phone, a personal digital assistant (PDA), or any other device capable of connecting to a network. Each of the network devices 102-106 may be capable of communicating with another network device using at a wired protocol, or a wireless protocol. Each connection in the connections 108-112 may be a wired connection or a wireless connection. A wired connection may use a wired protocol, such as Ethernet. A wireless connection may use a wireless protocol, such as Code Division Multiple Access (CDMA), Global System for Mobile (GSM), Bluetooth, Wireless Universal Serial Bus (USB), or IEEE 802.11 (“Wi-Fi”).

The router 114 may be connected via a modem 116 to an Internet Service Provider (ISP) 118. The ISP 118 may provide access to a public network 120, such as the Internet. A server 122 may be accessible to ISP 118. The server 122 may be used to provide software for securing a network, such as the network 124. The server 122 may also register the network devices 102-106 belonging to a subscriber of the ISP 118 when securing the network 124.

The network devices 102, 104, and 106 may have modules 130, 132, and 134, respectively. Each module in the modules 130-134 may be stored in a memory (not shown) and contain instructions capable of being executed by a processor (not shown). Each of the modules 130-134 may be executed by a processor (not shown) to secure the network 124.

The network devices 102-106 and the router 114 may be part of a network 124. In this example, the network 124 is shown with three network devices, the network devices 102-106. However, the number of network devices in the network 124 may be fewer than three or greater than three. In order to secure the network 124, a software 126 may be installed on one network device of the network devices 102-106. For example, the software 126 may be first installed on the network device 102 as the module 130. The module 130 contains instructions capable of being executed by a processor. In one embodiment, the software 126 may be on a storage device accessible to the network device 102, such as a Compact Disc Read Only Memory (CD-ROM) or a Universal Serial Bus (USB) memory drive. In another embodiment, the software 126 may be supplied by the ISP 118 and downloaded from the server 122. If the software 126 is supplied by the ISP 118, then the server 122 may allow the software 126 to be downloaded only after determining that the router 114 or the modem 116 is owned by a subscriber of the ISP 118.

After the software 126 is installed on network device 102 as module 130, the module 130 may determine the capabilities of network device 102. For example, the module 130 may determine whether the network device 102 is capable of making a wireless connection with a wireless router, such as the router 114. The module 130 may also determine whether the router 114 has a private Internet Protocol (IP) address. The module 130 may determine the security features of the router 114, such as the type of encryption used by the router 114. For example, the type of encryption for a Wi-Fi network may be Wired Equivalent Privacy (WEP) or Wi-Fi Protected Access (WPA). The module 130 may determine the Service Set IDentifier (SSID) of the router 114. The module 130 may also determine the Basic Service Set Identifier (BSSID) of the router 114. In one embodiment, the module 130 may determine whether the router 114 or the modem 116 is owned by a subscriber of the ISP 118.

After analyzing the capabilities of the network device 102, the module 130 may display an indication of the capabilities of the network device 102. For example, the module 130 may use a traffic light metaphor to graphically indicate the capabilities of the network device 102. In the traffic light metaphor, a red light may indicate that the network device 102 is not capable of wireless networking; a yellow light may indicate that the network device 102 is wirelessly connected to the router 114, but that the wireless connection 108 has no security or the security is below a security threshold; and a green light may indicate that the network device 102 is wirelessly connected to the router 114 with an adequate amount of security. The module 130 may also provide a selection mechanism for a user to select whether the user wishes to secure the network 124. The network 124 may be secured by securing the router 114 and by securing each network device capable of wirelessly connecting to the router 114.

After a user indicates that the user wishes to secure network 124, the module 130 may begin the process of securing the network 124. For example, the software 126 may be installed on one or more of the network devices 102-106 in the network 124. An executor may be selected from among the network devices 102-106 using different criteria. The executor may control and configure the router 114.

To control and configure the router 114, the executor may determine the identity of the router 114. For example, the router may search in a Hypertext Markup Language (HTML) page 115 of the router 114 for text that identifies a manufacturer and model number of the router 114. If the executor determines the manufacturer and the model number of the router 114, then the executor may determine a set of HTML commands based on the manufacturer and the model number of the router 114. In a particular embodiment, the executor may determine the set of HTML commands by retrieving the HTML commands from a database based on the manufacturer and the model number of the router 114. For example, the set of HTML commands in the database may be a set of POST commands. The set of HTML commands is one or more HTML commands. Each HTML command may submit data for the router 114 to process.

The set of HTML commands may be used to configure the router 114. The database may be part of the software 126. Additionally, the database may be in one of the modules 130-134. Additionally, the database may be at the server 122. The database may also contain a default username and/or a default password used with the set of HTML commands to configure the router 114. If the executor is not able to access the router 114 with the default username and/or password, the executor may prompt the user to enter a user name and password.

If the identity of the router 114 is not in the database, then the executor may attempt to determine the commands used to configure the router 114. For example, the executor may search for characteristics of HTML INPUT elements in web management pages of the router 114. A router manufacturer may provide web management pages for use in configuring the router 114. The web management pages may be used to accept input, using HTML INPUT elements, from a user in order to configure the router 114. The executor may analyze the web management pages of the router 114 to determine how to configure the router 114.

If the executor is wirelessly connected to the router, then the current SSID, BSSID, and WEP key may be determined and sent to the network devices 102-106. If the executor is not wirelessly connected to the router, then the executor may send a request to the network devices 102-106, asking for a set of known SSID-BSSID pairs. Each of the network devices 102-106 may respond by sending the executor a set of known SSID-BSSID pairs. The executor may receive the set of known SSID-BSSID pairs from each of the network devices 102-106, combine each set of known SSID-BSSID pairs into a combined set of known SSID-BSSID pairs, and then store the combined set of known SSID-BSSID pairs. The executor may ask the user to enter a MAC address. The executor may determine whether the MAC address entered by the user matches one of the BSSIDs in the combined set of known SSID-BSSID pairs. If the MAC address entered by the user matches one of the BSSIDs in the combined set of known SSID-BSSID pairs, then the corresponding SSID-BSSID pair may be used to configure the router 114.

The executor may start at the root HTML page of the router 114, and follow links, such as the <a>, <iframe>, and <frame> links in the HTML web management pages of the router 114, copying some or all of the HTML content in the HTML web management pages of the router 114. During this process, the executor may ignore some or all of the non-HTML content. If the executor has not yet identified the SSID of the router 114, then if a BSSID found in the copied HTML content matches one of the BSSIDs in the combined set of known SSID-BSSID pairs, then the corresponding SSID-BSSID pair may be used to configure the router 114. If the executor is unsuccessful in accessing the router 114 using information found at a specific HTML page in the copied HTML content, then the HTML page maybe added to a set of HTML pages which did not contain information relevant to configuring the router 114.

The executor may send a copy of the root HMTL page of the router 114 to the server 122 and request the server 122 to determine if the root HTML page of the router 114 matches an entry in a database of router configuration information at the server 122. If the server 122 determines that the root HTML page of the router 114 matches an entry in the database of router configuration information at the server 122, then the server 122 may send configuration data for the router 114 from the database of router configuration information to the executor. The server 122 may also send to the network devices 102-106 a unique identifier, such as a unique number, identifying the executor.

The executor may set the SSID of the router 114. Before setting the SSID for the router 114, the executor may first create a set of SSID candidates. If the executor has a previous set of candidate SSIDs, the previous candidate SSIDs may be removed from the set of candidate SSIDs. In the copied HTML content of the router 114, each HTML input element with a type of “text” may be added as a candidate SSID. If the executor does not find any candidate SSIDs, then a user may be notified that the executor was unable to find a candidate SSID. If the executor knows the current SSID of the router 114 by means of a current wireless connection to the router, and the current SSID matches a candidate SSID on the set of candidate SSIDs, then the current SSID may be used, and all other candidate SSIDs may be removed from the set of candidate SSIDs.

If the executor determines that a candidate SSID has a value that is in the set of potential SSIDs, then all other candidate SSIDs may be removed from the set of candidate SSIDs. The set of potential SSIDs is determined from a database of known SSIDS for routers. If the executor determines that a candidate SSID matches an SSID received from the server 122, then all other candidate SSIDs may be removed from the set of candidate SSIDs. If the executor determines that the length of a candidate SSID is less than or equal to a previously specified size, then all other candidate SSIDs may be removed from the set of candidate SSIDs. For example, if the previously specified size is thirty-two characters, then any candidate SSID with a length of thirty-two characters or less may be selected as the SSID for the router 114. The HTML maxLength command may be used to determine the length of a candidate SSID. If the executor determines that a candidate SSID appears on a page of the copied HTML content which also contains a text field including the letters “SSID”, “service set identifier”, or “service set id”, in any combination of upper or lowercase letters, then all other candidate SSIDs may be removed from the set of candidate SSIDs.

Each time the executor finds a candidate SSID in the copied HTML content of the router 114, the executor may send a message to the network devices 102-106 identifying the candidate SSID and informing the network devices 102-106 that the executor is attempting to access the router using the candidate SSID. The executor may send an HTML command, such as a POST command, to the router 114. For example, the executor may send a POST command containing the candidate SSID to the router 114. If the executor is capable of connecting to a wireless network, then the executor may store the state of the wireless connection and attempt to wirelessly connect to the router 114 using the candidate SSID. If the executor determines that the router 114 is using an encryption protocol, such as Wired Equivalent Privacy (WEP), the executor may attempt to connect to the router 114 using the encryption protocol. If the executor is able to connect to the router 114, then the executor may configure the router 114. If the executor is not able to connect to the router 114, then the executor may restore the stored state of the wireless connection.

If the executor is not capable of connecting to a wireless network then one or more of the network devices 102-106 may be instructed to attempt to access the router 114. If one of the network devices 102-106 is able to access the router 114, then the network device that is accessing the router 114 may send a message to the executor that it was successful in connecting to the router 114. The network device accessing the router 114, or the executor which receives the message, may set the SSID of the router 114. If the router uses an encryption protocol, such as Wired Equivalent Privacy (WEP), then the network device that is accessing the router 114 may send the executor a message containing information about the encryption protocol being used by the router 114, such as the type of encryption protocol being used, or the security key being used for the encryption protocol.

If the executor receives a message that one of the network devices 102-106 was able to access the router 114, then the executor may enable an encryption protocol, such as WEP. For example, the executor may search copied HTML content for HTML input elements, and any HTML input elements of type “option” or “radio” may be considered as candidate WEP controls. Any “option” HTML input element which is selected or checked may be removed from consideration as candidate WEP controls. If any candidate HTML input elements match HTML input elements previously sent by the server 122, then the matching HTML input elements may be selected as the candidate WEP controls and all other candidates may be removed from consideration. Any “option” HTML input element within a “select” HTML input element may be removed from consideration.

If any candidate HTML input elements display text which includes “WEP” then all other HTML input elements may be removed from consideration as candidate WEP controls. If any candidate HTML input elements display text which includes “128” then all other HTML input elements may be removed from consideration as candidate WEP controls. If any candidate HTML input elements display text which includes “104” then all other HTML input elements may be removed from consideration as candidate WEP controls. If any candidate HTML input elements display text which includes “security” then all other HTML input elements may be removed from consideration as candidate WEP controls. If any candidate HTML input elements display text which includes “encryption” then all other HTML input elements may be removed from consideration as candidate WEP controls. If there are no candidate WEP candidates, the user may be notified that WEP could not be set for the router 114.

If there are one or more WEP candidates, then the executor may select a WEP candidate and attempt to set WEP encryption for the router 114 using the selected WEP candidate. After the executor selects a WEP candidate, the executor may notify the network devices 102-106 that the executor is experimentally enabling WEP. The executor may send a POST command based on the selected WEP candidate to the router 114. If the POST command based on the selected WEP candidate sets the WEP encryption for the router 114, then WEP encryption may be enabled for the router 114. If the POST command based on the selected WEP candidate does not set the WEP encryption for the router 114, then the selected WEP candidate may be removed from consideration, another WEP candidate may be selected, and the previous process may be repeated until WEP is enabled for the router 114 or there are no more candidates.

If the executor is capable of wirelessly connecting to the router 114, then the executor may attempt to connect to the router 114 using WEP. If the executor is able to connect to the router 114 using WEP, then WEP has been enabled for the router 114 and the executor may set the WEP key. If the executor is unable to connect to the router 114 using WEP, then the executor may attempt to connect to the router 114 without using WEP. If the executor is unable to connect to the router 114 without using WEP, the executor determines if the executor is capable of connecting to the router 114 using a wired connection. If the executor determines that the executor is capable of connecting to the router 114 using a wired connection, then the executor may connect to the router 114 using the wired connection.

If the executor determines that the executor is not capable of connecting to the router 114 using a wired connection, then the executor may display a message instructing the user to connect the executor to the router 114 using a wired connection. If the executor is not capable of wirelessly connecting then the executor may instruct one or more of the network devices 102-106 to attempt to wirelessly connect to the router 114. If one of the network devices 102-106 is able to wirelessly connect to the router 114, then the network device that is wirelessly connecting to the router 114 may send a message to the executor that it was successful in connecting to the router 114.

The network device which is accessing the router 114 may send the executor a message containing information, such as whether the network device was able to access the router 114 with WEP enabled or whether the network device was able to access the router 114 with WEP disabled. The network device connecting to the router 114, or the executor which receives the message, may set WEP for the router 114. If none of the network devices 102-106 are able to connect to the router 114, with or without WEP enabled, then a POST command may be sent to the router 114 to set the values back to the previous values, a new candidate WEP is chosen, and the above process may be repeated.

After setting WEP for the router 114, the executor may set the WEP key. For example, the executor may search the copied HTML content of the router 114 for HTML input elements, and any HTML input elements of type “text” may be considered as a candidate WEP key. If the POST command used to set the SSID changed only one text input, and that input is a candidate WEP key, then the candidate WEP key may be removed from consideration as a candidate.

If a candidate WEP key matches an HTML input element previously sent by the server 122, then the matching HTML input elements may be selected as the candidate WEP and all other candidates may be removed from consideration. If no candidate WEP keys has a length of ten or twenty-six characters and the executor was able to enable WEP, then the executor may replace the copied HTML page with a new copy from the router. The executor may search the copied HTML content for HTML input elements and any HTML input elements of type “text” may be considered as a candidate WEP key.

The HTML maxLength command may be used to determine the length of a candidate WEP key. Any candidate that does not have a length of ten or twenty-six characters may be removed from consideration as a candidate. If there are no candidate WEP keys then the user may be advised that no candidate WEP keys are available. If any candidate WEP key has a length of twenty-six characters, then all other candidates may be removed from consideration as a candidate. If any candidate WEP key has a length of ten characters, then all other WEP key candidates may be removed from consideration.

If any candidate WEP key is associated with an HTML field containing the text “WEP”, “key”, “security” or “encryption”, in any combination of upper or lowercase letters, then all other WEP key candidates may be removed from consideration. If the executor was able to enable WEP for the router 114 and if a WEP key candidate is on the same HTML web management page which successfully enabled WEP, then all other WEP key candidates may be removed from consideration.

For each page of the copied HTML content that contains at least one candidate WEP key, the executor may attempt to set the WEP key for the router 114. If the executor previously enabled WEP, and the HTML page used to enable WEP did not change after the executor enabled WEP, the executor may obtain a new copy of the HTML web management page from the router 114 and replace the copied HTML web management page with the new copy of the HTML web management page.

The executor may send a message to the network devices 102-106 indicating that the executor is attempting to set the WEP key for the router 114. For each candidate WEP key, the executor may send a POST command, based on the candidate WEP key, to the router 114. For example, a candidate WEP key with a length of ten characters may be sent in a POST command in an American Standard Code for Information Interchange (ASCII) based format. A candidate WEP key that has a length different than ten characters may be sent in a POST command in a twenty-six digit, hexadecimal-based, format.

If the executor previously set the SSID or enabled WEP, one or more of the values used to set the SSID or enable WEP may be sent, along with the candidate WEP key, in a POST command. If the executor is not able to use a page using the candidate WEP key, then that candidate WEP key may be removed from consideration. If the executor is capable of wirelessly connecting to the router 114, then the executor attempts to connect to the router 114 based on the previously set SSID and based on the candidate WEP key. If the executor is successful in connecting to the router 114 using the previously set SSID and the candidate WEP key, then the executor has set the WEP key for the router 114 and the executor may execute a cleanup process. If the executor is successful in connecting to the router 114 using the previously set SSID and the candidate WEP key, then the executor may attempt to reconnect to the router 114.

The executor may attempt to reconnect to the router 114 by using a previous WEP key, if known, or without WEP. If the executor is capable of connecting to the router 114 using a wired connection, then the executor may send a POST command to the router 114 to restore the values which were in the router 114 prior to the executor trying the candidate WEP key. If the executor cannot connect to the router 114, then the executor may display a message asking the user to connect the executor to the router 114 using a wired connection. If the executor determines the executor is capable of connecting to the router 114 using the wired connection, then the executor may send a POST command to the router 114 to restore the values which were in the router 114 prior to the executor trying the candidate WEP key.

If the executor is not capable of wirelessly connecting to the router 114 then the executor may instruct one or more of the network devices 102-106 to attempt to wirelessly connect to the router 114 using the previously set SSID) and the candidate WEP key. If the network devices 102-106 are all not able to wirelessly connect to the router 114 using the previously set SSID and the candidate WEP key, then the network devices 102-106 may reestablish any previous connectivity to the router 114 and may notify the executor that none of them was successful.

If one of the network devices 102-106 is able to connect to the router 114 using the previously set SSID and the candidate WEP key then that network device may notify the executor that the network device was successful, and notifies the executor of the SSID and WEP key used to connect to the router 114. If the executor receives a message indicating that one of the network devices 102-106 was able to connect to the router 114 using the previously set SSID and the candidate WEP key, then the executor may execute a cleanup process.

The executor may execute a cleanup process which cleans up any changes made to the router 114 which did not contribute to setting the router 114. For each page of copied HTML content, the executor may get one or parameters from the router 114. The executor may then send a message to the network devices 102-106 notifying them that one or more parameters may revert back to previous values. The executor may send a POST command to the router 114. For example, the POST command may contain parameters that were successfully used to set the SSID, enable WEB, or set the WEP key, or the POST command may contain the original parameters found in the copied HTML content. If the executor does not have a wired connection to the router 114, and the executor is not able to reconnect to the router 114, the executor may try to connect to the router 114 with WEP and without WEP, using the value of each text input that the executor changes as a potential SSID and WEP key. If the executor is unsuccessful in wirelessly connecting to the router 114, then executor may display a message asking the user to connect the executor to the router 114 using a wired connection. If any computers are not able to reconnect to the router 114, then the POST command sent by the executor to the router 114 may contain any previously used parameters.

If the executor is successful in configuring the router 114 by setting the SSID, enabling WEP, and setting the WEP key, then the executor may store the HTML input elements, including the form and page they were found in, in a database. For example, the executor may send the HTML input elements to the server 122, and the server 122 may store the HTML input elements in a database for use in configuring other similar routers.

After the executor determines that the router 114 may be accessed, the executor device may ask the user if the user wishes to secure the network 124. If the executor determines that the user wishes to secure the network 124, then a message may be sent to all the network devices 102-106 indicating that the network 124 will be secured. The executor may configure the router 114 for providing a secure wireless network. The non-executor network devices may also modify their wireless network access settings based on the message.

After the network 124 is secured, each of the modules 130-134 in the network devices 102-106, respectively, may actively monitor and maintain the connections 108-112 to the router 114. For example, when the network device 106 is powered on or re-started, the module 134 may be executed by a process to monitor, configure, and/or maintain the connection 112 with router 114.

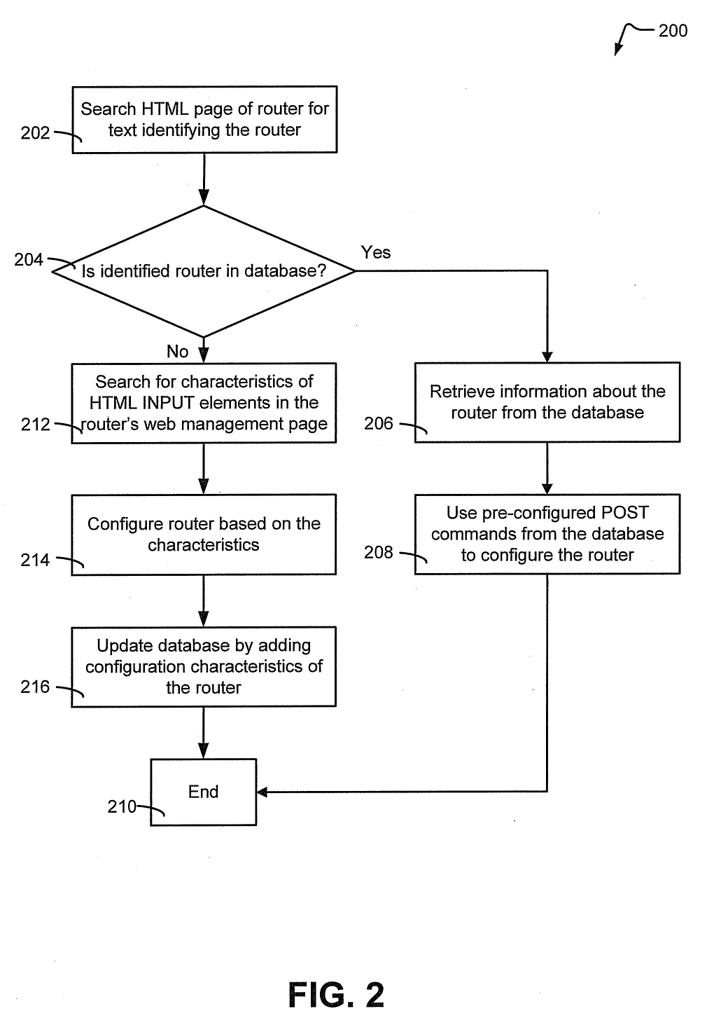

Referring to FIG. 2, a flow chart of a first illustrative embodiment of a method of controlling and configuring a router is depicted and generally designated 200. The method 200 can be executed via a software module at a network device capable of connecting to the network, such as the network device 102, the network device 104, or the network device 106 in FIG. 1.

The method 200 may include searching the HTML page of a router for text identifying the router, at 202. For example, the router may be a router, such as the router 114 in FIG. 1. The method may include determining whether the identified router is in a database, at 204. For example, one of the network devices 102-106 may ask a server, such as server 122 in FIG. 1, to determine whether the identified router is in a database.

The database may be located on a server, such as the server 122, or the database may be located in software, such as the software 126, or in a module, such as one of modules 130-134. The database may contain information about configuration characteristics of different routers.

If the identified router is in the database, then information about the router may be retrieved from the database, at 206, pre-configured POST commands from the retrieved information may be used to configure the router, at 208, and the method may end, at 210. If the router is not in the database, then the router's web management pages may be searched for characteristics of HTML input elements, at 212.

The router may be configured based on the characteristics of the HTML input elements, at 214. The database may be updated by adding the configuration characteristics of the router to the database, at 214. The method may end, at 210.

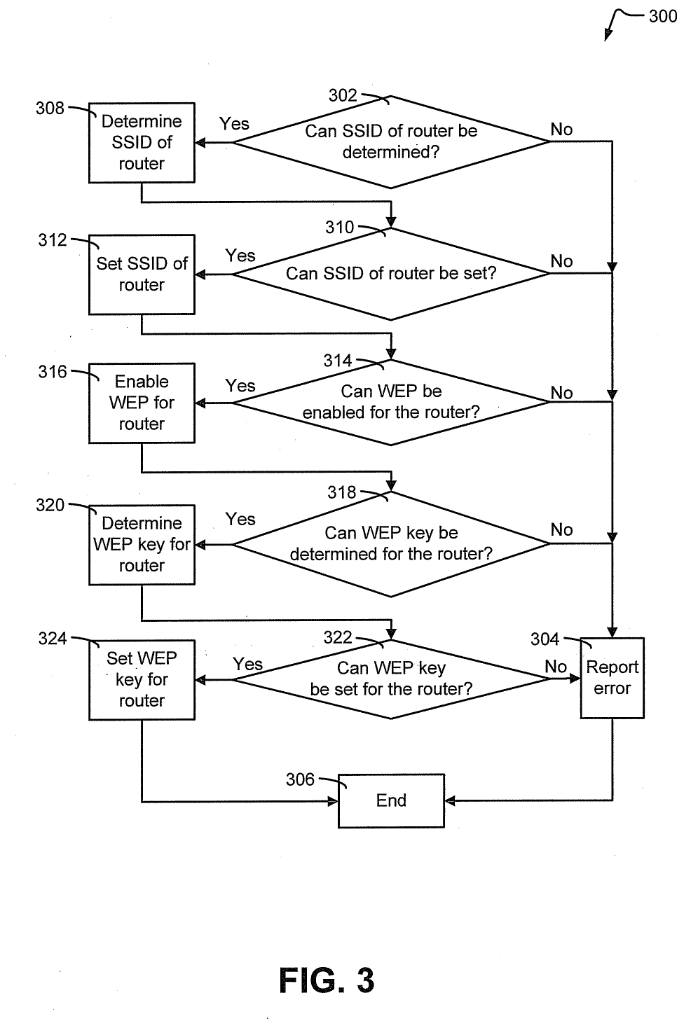

Referring to FIG. 3, a flow chart of a second illustrative embodiment of a method of controlling and configuring a router is depicted and generally designated 300. The method 300 can be executed via a software module at a network device capable of connecting to the network, such as the network device 102, the network device 104, or the network device 106 in FIG. 1.

The method 300 may include determining whether the SSID of the router can be determined, at 302. The router may be a router, such as the router 114 in FIG. 1. If the SSID of the router cannot be determined then the error may be reported, at 304, and the method may end, at 306. For example, the error may be reported to a user or a subscriber. If the SSID of the router can be determined, then the SSID of the router may be determined, at 308. A determination may be made whether the SSID of the router can be set, at 310. If the SSID of the router cannot be set, then the error may be reported to the user, at 304, and the method may end, at 306. If the SSID of the router can be set, then the SSID of the router may be set, at 312.

A determination may be made whether WEP can be enabled for the router, at 310. If WEP cannot be enabled for the router, then the error may be reported to the user, at 304, and the method may end, at 306. If WEP can be enabled for the router, then WEP may be enabled for the router, at 316.

A determination may be made whether the WEP key can be determined, at 318. If the WEP key cannot be determined for the router, then the error may be reported to the user, at 304, and the method may end, at 306. If the WEP key can be determined, then the WEP key may be determined, at 320.

A determination may be made whether the WEP key can be set for the router, at 322. If the WEP key cannot be set for the router, then the error may be reported to the user, at 304, and the method may end, at 306. If the WEP key can be set for the router, then the WEP key may be set for the router, at 324, and the method may end, at 306.

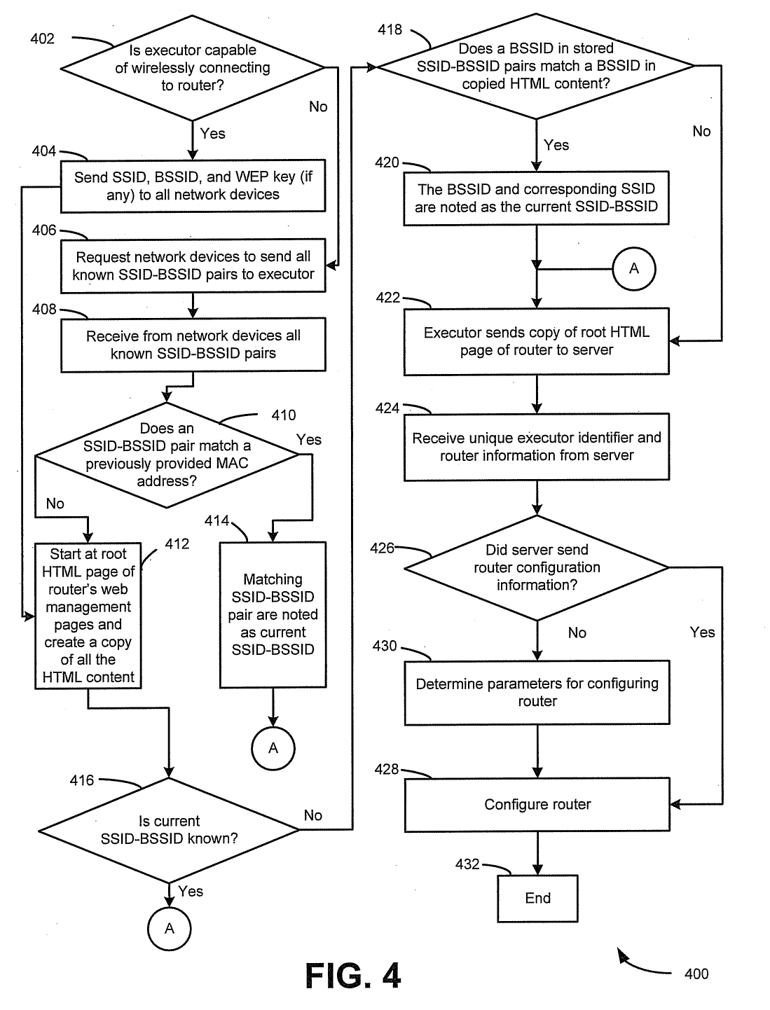

Referring to FIG. 4, a flow chart of a third illustrative embodiment of a method of controlling and configuring a router is depicted and generally designated 400. The method 400 can be executed via a software module at a network device capable of connecting to the network, such as the network device 102, the network device 104, or the network device 106 in FIG. 1. The software module may, for example, be software, such as software 126, installed on a network device, such as network device 102.

A determination may be made whether the executor is connected wirelessly to the router, at 402. If the executor is connected wirelessly to the router, then the current SSID, BSSID, and WEP key (if any) may be sent to network devices, at 404, and the method proceeds to step 412. The network devices may be network devices, such as network devices 102-106. If the executor is not wirelessly connected to the router, then the executor may send a request to the network devices, asking for any known SSID-BSSID pairs, at 406. The executor may receive a set of known SSID-BSSID pairs from the network devices, at 408. The executor may determine whether a MAC address previously entered by a user matches one of the BSSIDs in the set of known SSID-BSSID pairs, at 410. If the MAC address entered by the user matches one of the BSSIDs in the set of known SSID-BSSID pairs, then the corresponding SSID-BSSID pair may be used to configure the router, at 414, and the method proceeds to step 422.

If the MAC address entered by the user does not match any of the BSSIDs in the set of known SSID-BSSID pairs, then the executor may start at the root HTML page of the router 114, and copy the HTML content in the HTML web management pages of the router 114, at 412. A determination may be made whether the current SSID-BSSID pair is known, at 416. If the current SSID-BSSID pair is known, then the method may proceed to step 422. If the current SSID-BSSID is not known, then a determination may be made whether a BSSID found in the copied HTML content matches one of the BSSIDs in the set of known SSID-BSSID pairs, at 418. If a BSSID in the set of known SSID-BSSID pairs matches a BSSID in the copied HTML content, then the corresponding SSID-BSSID pair may be stored as the current SSID-BSSID, at 420.

The executor may send a copy of the root HMTL page of the router to a server, at 422. For example, the executor may send the root HTML page of the router to a server, such as the server 122 in FIG. 1, and request the server 122 to determine if the root HTML page of the router 114 matches an entry in a database of router configuration information at the server 122. The executor may receive a unique identifier identifying the executor, and router information from the server, at 424. A determination may be made whether the router information sent by the server contains configuration information for configuring the router, at 426. If the router information contains configuration information, then the executor may configure the router, at 428, and the method may end, at 432. If the router information does not contain configuration information, then the executor may determine the parameters for configuring the router, and may configure the router, at 430. The method may then end, at 432.

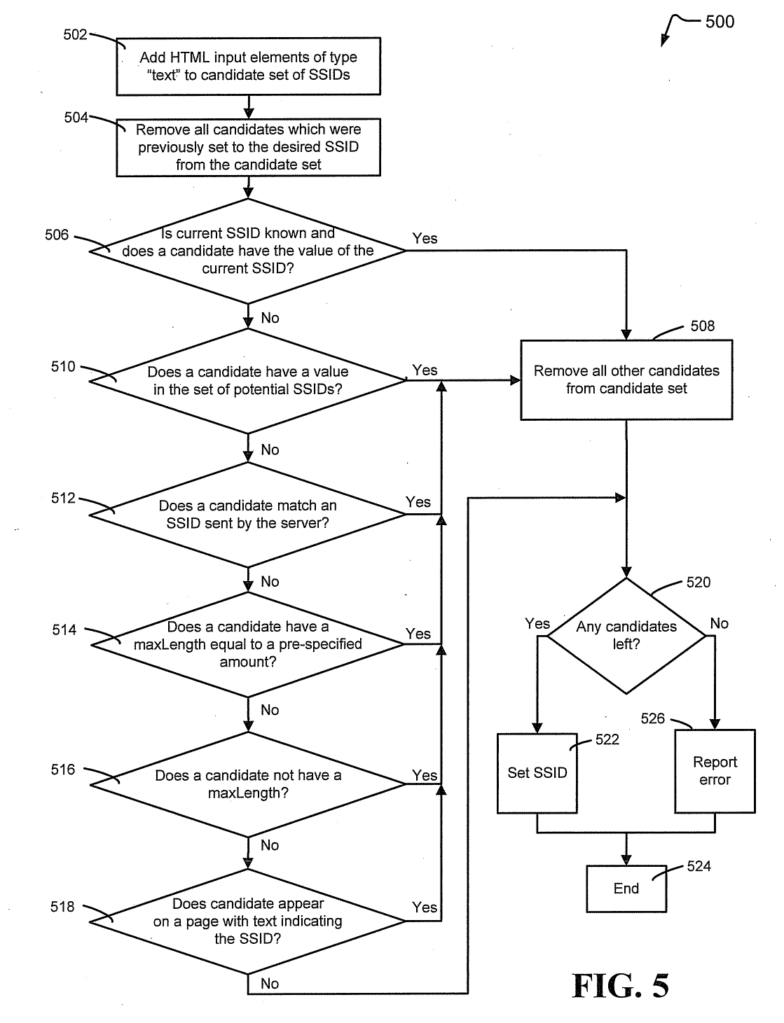

Referring to FIG. 5, a flow chart of a fourth illustrative embodiment of a method of controlling and configuring a router is depicted and generally designated 500. The method 500 can be executed via a software module at a network device capable of connecting to the network, such as the network device 102, the network device 104, or the network device 106 in FIG. 1. The software module may, for example, be software, such as software 126, installed on a network device, such as network device 102. The method 500 may be used to determine and set one or more parameters of a router, such as the router 114 in FIG. 1. For example, the method 500 may be used to determine and set an SSID for a router.

To determine an SSID to set for a router, an executor may add HTML input element of type of “text” to a set of candidate SSID, at 502. All candidates that were previously set to the desired SSID may be removed from the set of candidates, at 504. A determination may be made whether the current SSID is known and whether a candidate SSID matches the current SSID, at 506. If the current SSID is known, and a candidate SSID matches the current SSID, then all other candidate SSIDs may be removed from the set of candidate SSIDs, at 508, and the method may proceed to 520.

If the current SSID is not known or none of the candidate SSIDs match the current SSID, then a determination is made whether a candidate SSID has a value that is in the set of potential SSIDs, at 510. If a candidate SSID has a value that is in the set of potential SSIDs, then all other candidate SSIDs may be removed from the set of candidate SSIDs, at 508, and the method may proceed to 520. A determination may be made whether a candidate SSID matches an SSID previously received from a server, at 512. The server may be a server, such as server 122 in FIG. 1. If a candidate SSID matches an SSID previously received from a server, then all other candidate SSIDs may be removed from the set of candidate SSIDs, at 508, and the method may proceed to 520.

A determination may be made whether the maxLength of a candidate SSID is equal to a previously specified size, at 514. The HTML maxLength command may be used to determine the maximum number of characters in a text field. If the maxLength of a candidate SSID is equal to a previously specified size then all other candidate SSIDs may be removed from the set of candidate SSIDs, at 508, and the method may proceed to 520. For example, if the previously specified size is thirty-two characters, then any candidate SSID with a length of thirty-two characters may be selected as the candidate SSID and all other candidates may be removed from consideration. A determination may be made whether a candidate has no maxLength specified, at 516. If a candidate has no maxLength specified, then all other candidates may be removed from consideration, at 508.

If a candidate has a maxLength specified, then a determination may be made whether a candidate SSID appears on an HTML page with a text field indicating the SSID, at 518. For example, a text field with the text “SSID”, “service set identifier”, or “service set id”, in any combination of upper or lowercase letters, may be considered a text field indicating the SSID. If a candidate SSID appears on an HTML page indicting the SSID, then all other candidate SSIDs may be removed from the set of candidate SSIDs, at 508, and the method may proceed to 520.

If a candidate SSID does not appear on an HTML page indicating the SSID, then a determination may be made whether any candidates are left, at 520. If there is at least one candidate left, then the SSID may be set, at 522, and the method ends at 524. If no candidates are left, then an error may be reported, at 526, and the method may end at 524.

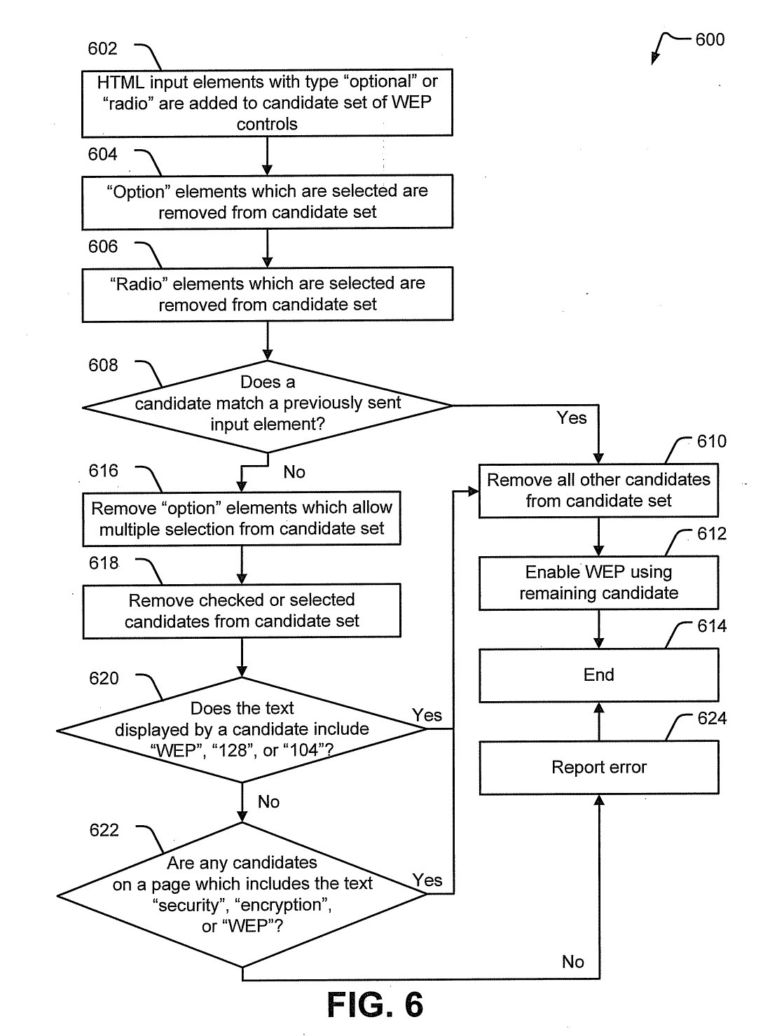

Referring to FIG. 6, a flow chart of a fifth illustrative embodiment of a method of controlling and configuring a router is depicted and generally designated 600. The method 600 can be executed via a software module at a network device capable of connecting to the network, such as the network device 102, the network device 104, or the network device 106 in FIG. 1. The software module may, for example, be software, such as software 126, installed on a network device, such as network device 102. The method 600 may be used to determine and set one or more parameters of a router, such as the router 114 in FIG. 1. For example, the method 600 may be used to determine and enable an encryption protocol, such as WEP, for a router.

At 602, HTML input elements with type “option” or “radio” may be added to a set of candidate WEP controls. At 604, “option” HTML input elements that are in a selected state may be removed from the candidate set. At 606, “radio” HTML input elements that are in a selected state may be removed from the candidate set. At 608, a determination may be made whether a candidate matches a previously sent HTML input element. For example, a server, such as the server 122 in FIG. 1 may send an HTML input element when the server sends an executor identifier. If a candidate matches a previously sent HTML input element, then all other candidates may be removed from the candidate set at 610, WEP may be enabled using the candidate at 612, and the method may end at 614.

If at 608 a candidate does not match a previously sent HTML input element, then all “option” elements that allow multiple selection may be removed from the candidate set at 616. At 618, all candidates that are checked or selected may be removed from the candidate set. At 620, a determination may be made whether the text displayed by a candidate includes the characters “WEP”, “128”, or “104”. If the text displayed by a candidate includes the characters “WEP”, “128”, or “104”, then all other candidates may be removed from the candidate set at 610, WEP may be enabled using the candidate at 612, and the method may end at 614.

If the text displayed by each candidate in the candidate set does not include the characters “WEP”, “128”, or “104”, then at 622 a determination may be made whether any candidates are on a page which includes the text “security”, “encryption”, or “WEP”. The text “security”, “encryption”, or “WEP” may be in any combination of uppercase and lowercase characters. If a candidate is on a page that includes the text “security”, “encryption”, or “WEP”, then all other candidates may be removed from the candidate set at 610, WEP may be enabled using the candidate at 612, and the method ends at 614. If none of the candidates are on a page that includes the text “security”, “encryption”, or “WEP”, then an error may be reported at 624, and the method ends at 614.

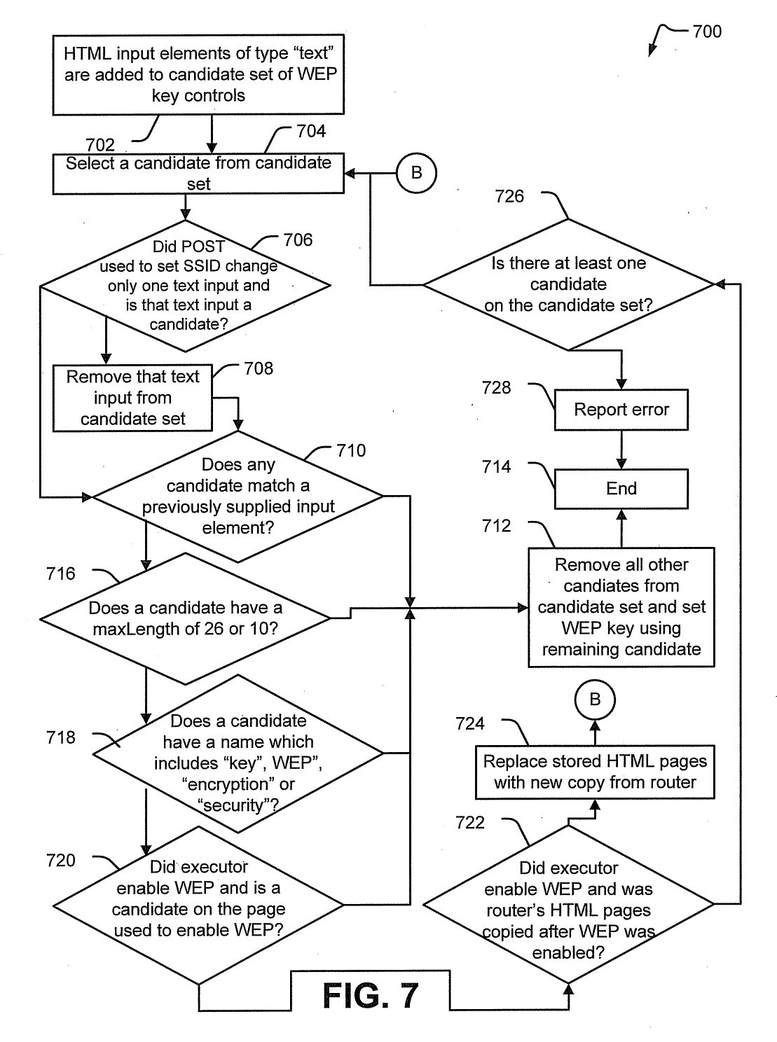

Referring to FIG. 7, a flow chart of a sixth illustrative embodiment of a method of controlling and configuring a router is depicted and generally designated 700. The method 700 can be executed via a software module at a network device capable of connecting to the network, such as the network device 102, the network device 104, or the network device 106 in FIG. 1. The software module may, for example, be software, such as software 126, installed on a network device, such as network device 102. The method 700 may be used to set one or more parameters of a router, such as the router 114 in FIG. 1. For example, the method 700 may be used to determine and set an encryption key, such as a WEP key, for a router.

At 702, HTML input elements of type “text” may be added to a candidate set of WEP key controls. At 704, a candidate may be selected from the candidate set. At 706, a determination may be made whether a POST command previously used to set the SSID changed only one text input and whether that text input is a candidate. If at 706 the POST command previously used to set the SSID changed only one text input and that text input is a candidate, then that candidate may be removed from the candidate set at 708, and the method continues to step 710. If at 706 a determination is made that the POST command previously used to set the SSID changed only one text input but that text input is not a candidate, then at step 710, a determination may be made whether any candidate matches a previously supplied input element. For example, a server, such as the server 122 in FIG. 1 may send an input element when the server sends an executor identifier.

If at 710 a candidate matches a previously supplied input element, then at 712 all other candidates may be removed from the candidate set, the WEP key may be set using the remaining candidate, and the method ends at 714. If at 710 none of the candidates match a previously supplied input element, then at 716 a determination may be made whether a candidate has a maxLength of 26 or 10. If at 716 a candidate is determined to have a maxLength of 26 or 10, then at 712 all other candidates may be removed from the candidate set, the WEP key may be set using the remaining candidate, and the method ends at 714. If at 716 a determination is made that none of the candidates have a maxLength of 26 or 10, then at 718 a determination may be made whether a candidate has a name that includes the characters “key”, “WEP”, “encryption”, or “security”. If at 718 a determination is made that the candidate has a name that includes the characters “key”, “WEP”, “encryption”, or “security”, then at 712 all other candidates may be removed from the candidate set, the WEP key may be set using the remaining candidate, and the method ends at 714.

If at 718 a determination is made that the candidate does not have a name that includes the characters “key”, “WEP”, “encryption”, or “security”, then at 720 a determination may be made whether the executor enabled WEP and whether a candidate is on the page used to enable WEP. If at 720 a determination is made that the executor enabled WEP and that a candidate is on the page used to enable WEP, then at 712 all other candidates may be removed from the candidate set, the WEP key may be set using the remaining candidate, and the method may end at 714.

If at 720 a determination is made that none of the candidates are on the page the executor used to enable WEP then at 722 a determination may be made whether the executor enabled WEP and whether the router's HTML pages was copied after WEP was enabled. If at 722 a determination is made that the executor enabled WEP and the router's HTML pages were not copied after WEP was enabled, then at 724 a new copy of the HTML pages may be copied from the router and used to replace the stored HTML pages, and the method proceeds to 704 and a candidate may be selected from the candidate set.

If at 722 a determination may be made that the executor enabled WEP and the router's HTML pages were copied after WEP was enabled then at 726 a determination may be made whether the candidate set has at least one candidate. If at 726 a determination is made that there are no candidates on the candidate set, then at 726 an error may be reported and the method ends at 714. If at 726 a determination is made that there is at least one candidate left on the candidate set, then the method may proceed to 704 and a candidate may be selected from the candidate set.

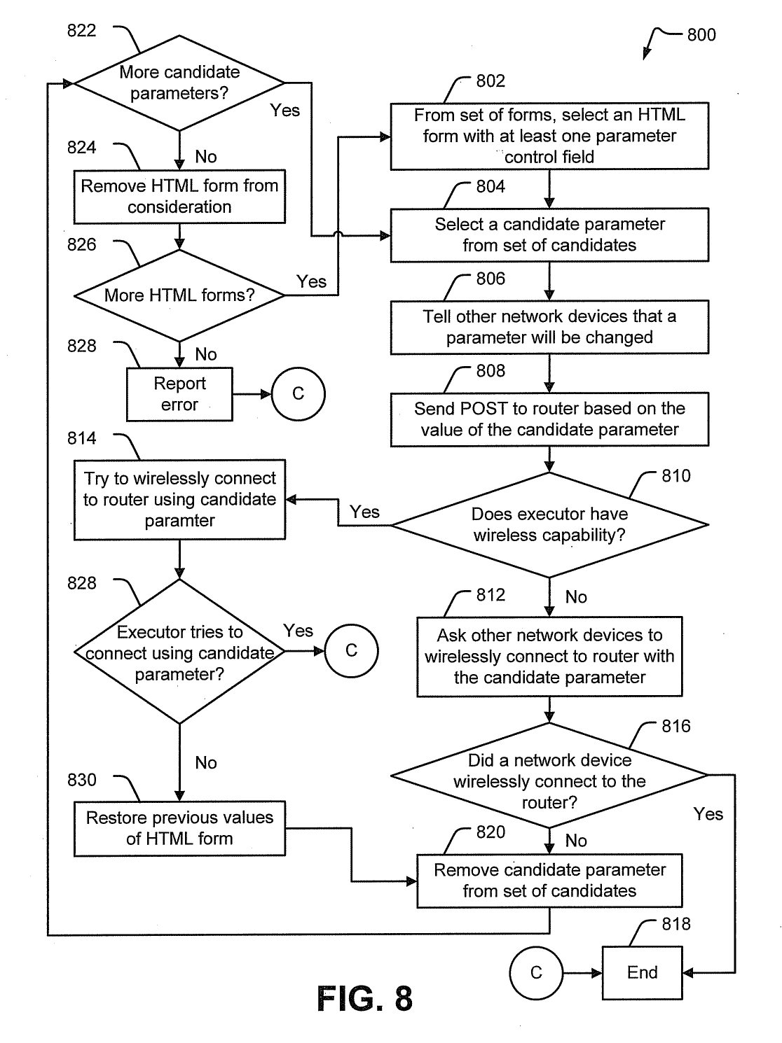

Referring to FIG. 8, a flow chart of a seventh illustrative embodiment of a method of controlling and configuring a router is depicted and generally designated 800. The method 800 can be executed via a software module at a network device capable of connecting to the network, such as the network device 102, the network device 104, or the network device 106 in FIG. 1. The software module may, for example, be software, such as software 126, installed on a network device, such as network device 102. The method 800 may be used to set one or more parameters of a router, such as the router 114 in FIG. 1. For example, the method 800 may be used to set SSID, enable encryption, such as WEP, and set an encryption key for the router.

At 802, an HTML form with at least one parameter control field may be selected from a set of forms. For example, when setting the SSID for the router, an HTML form containing at least one candidate SSID control field may be selected from a set of HTML forms. At 804, a candidate parameter may be selected from a set of candidates. For example, when setting the SSID for the router, a candidate SSID may be selected from a set of candidate SSIDs. At 806, other network devices may be informed that a parameter is being experimentally set. For example, an executor may send a message to the server 122, and the server 122 may notify each of the network devices 102-106 that a parameter of the router is being experimentally changed. At 808, a POST command based on the candidate parameter value may be sent to the router. At 810, a determination may be made whether the executor has the capability of wirelessly connecting to the router. For example, the executor may be capable of wirelessly connecting to the router if the executor has a wireless network adapter installed.

If the executor does not have the capability of wirelessly connecting to the router, then at 812 the executor asks the other network devices to try and connect wirelessly to the router with the candidate parameter, and the method proceeds to 828. If the executor does have the capability of wirelessly connecting to the router, then at 814 the executor tries to wirelessly connect to the router using the candidate parameter. At 816, a determination may be made whether a network device wirelessly connected to the router. If a network device was able to connect to the router, then the method ends at 818. If none of the network devices were able to wirelessly connect to the router then at 820 the candidate parameter may be removed from the set of candidates. At 822, a determination may be made whether there are any more candidate parameters.

If there are more candidate parameters, then the method goes to 804 and selects a candidate parameter from the set of candidates. If there are no more candidate parameters, then at 824 the HTML form may be removed from consideration. At 826, a determination may be made whether there are more HTML forms. If there are more HTML forms then the method goes to 802 and an HTML form with at least one parameter control field may be selected from the set of the forms. If there are no more HTML forms, then at 828 an error may be reported, and the method may end at 818.

At 828, a determination may be made whether the executor is wirelessly connected to the router using the candidate parameter. If the executor is wirelessly connected to the router, then the method may end at 818. If the executor is not wirelessly connected to the router, then the executor may restore the previously values of the HTML form, and the method continues at 820.

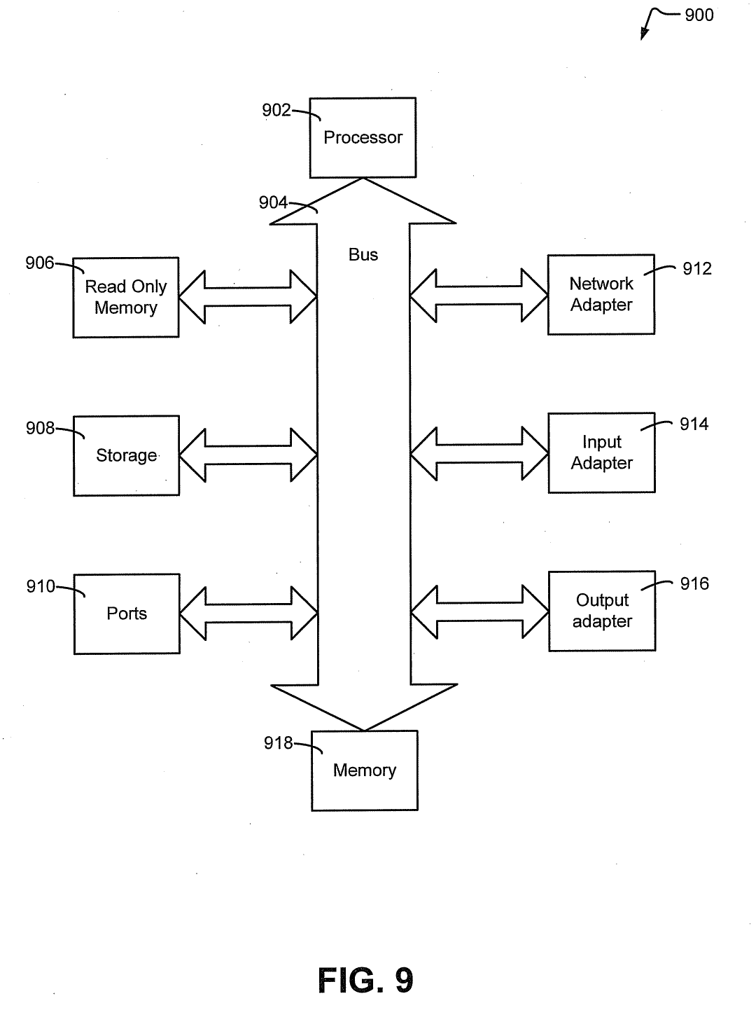

Referring to FIG. 9, a block diagram of an illustrative embodiment of a network device is depicted and generally designated 900. The network device 900 is an example of a network device, such as the network device 102, 104, or 106 in FIG. 1, in which a module, such as the modules 130, 132, or 134, respectively, may be located. In this illustrative embodiment, a processor 902 may connect to a bus 904. The processor 902 may be used to execute instructions contained in a module, such as the module 130 in FIG. 1. Connected to the bus 904 may be a read only memory 906. The read only memory 906 may contain instructions to load an operating system when the network device is powered on.

A storage 908 may also connect to bus 904. The storage 908 may be a data storage device, such as a hard disk drive, an optical storage drive, or a solid-state storage device, such as flash memory. Ports 910 may connect to the bus 904. The ports 910 may contain one or more ports, such as a Universal Serial Bus (USB) port, an Ethernet port, or an IEEE 1394 port. Network adapter 912 may connect to the bus 904. The network adapter 912 may be one or more adapters for connecting the network device 900 to different types of networks. For example, the network adapter 912 may be capable of wireless networking using a wireless connection protocol such as 902.11 (“Wi-Fi”), Wireless USB, Bluetooth, CDMA, or GSM.

An input adapter 914 may connect to the bus 904. The input adapter 914 may be capable of accepting input from one or more user input devices, such as a keyboard, a mouse, a speech recognition device, or a stylus. An output adapter 916 may also connect to bus the 904. The output adapter may be capable of outputting text and/or graphics to an output display device, such as a liquid crystal device (LCD) screen. A memory 918 may also connect to the bus 904. The memory 918 may contain a module, such as the module 130, executable by the processor 902.

In accordance with various embodiments of the present disclosure, the methods described herein may be implemented by software programs executable by a computer system. Further, the present disclosure contemplates a computer-readable medium that includes instructions to perform the methods described herein.

The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magnetic, magneto-optical, or optical medium, such as a disc drive or tapes or other storage device. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the disclosed embodiments are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. For example, substitutions may be made to search for language similar to the language used in the searches specified above, that is the lists of text to search for provided in this description is not exhaustive and the scope of the disclosure is intended to include any other words or text that may indicate the nature of what is being searched for.

Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.82(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
identifying a first network device in communication with a computer via a network;
searching a library of network device commands at the computer for commands that are associated with the first network device;
determining at the computer a set of commands that are executable by the first network device; and
sending at least one control command from the computer that is executable by the first network device to configure the first network device.

2. The method of claim 1, wherein the at least one control command is executable by the first network device to configure at least one of a network setting and a security setting.

3. The method of claim 1, wherein the network device is one of a computer, a server, a router, a printer, a modem, a switch, a gateway, and a portable device coupled to the network.

4. The method of claim 3, wherein the library includes a first set of commands that are specific to a first type of network device of a first vendor, and wherein the library includes a second set of commands that are specific to a second type of network device of a second vendor.

5. The method of claim 3, wherein the library does not include commands that are associated with the first network device, and further comprising:
querying the first network device to determine the at least one control command; and
adding the at least one control command to the library at the computer.

6. The method of claim 5, wherein the querying includes sending at least one message to the first network device to probe a network management interface; and further comprising:
detecting a response of the first network device to the at least one message; and
determining the set of commands that are executable by the first network device based on the response.

7. The method of claim 5, wherein the adding does not include a recompilation of the library of network device commands.

8. The method of claim 5, further comprising:
sending the at least one control command to a server that maintains the library of network device commands.

9. The method of claim 1, wherein the set of commands that are executable by the first network device are determined by user input at the computer, and further comprising:
recording the user input; and
adding the set of commands to the library of network device commands at the computer.

10. A system comprising:
a processor; and
a memory that is accessible to the processor, wherein the memory includes instructions that are executable by the processor to:
detect a network device that is accessible to the computer via a network;
probe a network management interface of the network device via the network;
determine a set of commands that are executable by the network device to configure the network device; and
store the set of commands in a library of network device commands.

11. The system of claim 10, wherein the memory includes instructions that are executable by the processor to automatically probe the network management interface, determine the set of commands that are executable by the network device, and store the set of commands, without requiring user input.

12. The system of claim 11, wherein the memory includes instructions that are executable by the processor to send at least one command to the network device to configure the network device based on at least one network policy.

13. The system of claim 12, wherein the network policy is at least one of a security policy and a configuration policy.

14. The system of claim 10, wherein the set of commands that are stored in the library of network device commands are indexed and retrievable by the processor without first operating on the library with a compiler.

15. The system of claim 10, wherein the probing includes sending a request to the network device for information corresponding to the network management interface.

16. The system of claim 10, wherein the probing includes performing at least one iteration of:
determining a trial configuration command to send to the network device;
sending the trial configuration command to the network device; and
determining a response of the trial configuration command at the network device.

17. A computer readable medium comprising computer readable instructions, wherein the computer readable instructions are executable by a processor to:
record user input at a computer, the user input corresponding to configuration commands that are executable by a network device that is in communication with the computer via a network;
generate a set of the configuration commands; and
store the set of configuration commands to a library of network device commands.

18. The computer readable medium of claim 17, wherein the computer readable instructions are further executable by the processor to:
retrieve at least one configuration command of the set of configuration commands from the library; and
send the at least one configuration command to the network device, wherein the library is not recompiled by a compiler before the at least one configuration command is retrieved.

19. The computer readable medium of claim 17, wherein the computer readable instructions are further executable by the processor to:
receive a network configuration policy;
determine that the network device does not comply with the network configuration policy; and
generate a prompt for the user input, wherein the network policy is at least one of a security policy and a configuration policy.

20. The computer readable medium of claim 17, wherein the network policy is a wireless network security policy.
